(19) United States
(12) Patent Application Publication
(10) Pub. No.: US 2020/0117332 A1
(43) Pub. Date: Apr. 16, 2020

(54) DEVICE HAVING MULTI-TOUCH APPLICATIONS

(71) Applicant: Lai Wa WONG, Hong Kong (CN)

(72) Inventor: Lai Wa WONG, Hong Kong (CN)

(21) Appl. No.: 16/624,238

(22) PCT Filed: Jun. 19, 2018
(86) PCT No.: PCT/IB2018/054493

§ 371 Date: Dec. 18, 2019

(30) Foreign Application Priority Data
Jul. 3, 2017 (HK) 17106596.6

(51) Int. Cl. G06F 3/041; G06F 3/0354; G06F 3/038

(52) U.S. Cl. CPC G06F 3/04162; G06F 3/038; G06F 3/03545

(57) ABSTRACT

The present invention provides a device having multi-touch applications comprising a body, the body comprises at least one input means, the input means comprises a plurality of contact members, the plurality of contact members comprises at least one electrically conductive contact member adapted to conduct electricity to an object, the number of the at least one electrically conductive contact member between each input means are different.

### FIELD OF THE INVENTION

The present invention relates broadly to a technical field of multi-touch technology. More specifically, the invention relates to a device having multi-touch applications which applies to multi-touch screen and multi-touch panels.

### BACKGROUND OF THE INVENTION

With the continuous development of touch technology, multi-touch technology has become a development trend. The device having multi-touch applications or components such as styluses currently used on the multi-touch screen and multi-touch panels, etc. can only achieve the touch operation of a single function. When multi-functional touch operation is to be performed, it is required to use different devices having multi-touch applications or components before it can be achieved, so the operation is very inconvenient, and is unable to meet the operation demands of the users.

### SUMMARY OF THE INVENTION

The problem to be solved in the present invention is to provide the device having multi-touch applications capable of achieving various different functions.

In the present invention, when the body comprises several input means and each input means comprises electrically conductive contact members of different numbers, and each input means controls several touch multi-touch screens and multi-touch panels, etc, the electrically conductive contact members of each input means can convey different signals to multi-touch screens and multi-touch panels, etc so as to achieve touch operation of different functions, thus having solved relatively single function problems achieved by the existing devices having multi-touch applications or components, and the present invention is simple in its structure, and convenient in manipulation, which meets the application demands of the users.

The present invention provides a device having multi-touch applications comprising a body, the body comprises at least one input means, the input means comprises a plurality of contact members, the plurality of contact members comprises at least one electrically conductive contact member adapted to conduct electricity to an object, the number of the at least one electrically conductive contact member between each input means are different.

Typically, top ends of the plurality of contact members of each input means are arranged on substantially same plane.

Typically, the body comprises at least one face which is made of electrically conductive material.

Typically, the body further comprises at least one face having a first concave region, the contact member is configured for being removably mounted to the concave region of the face.

Typically, the first concave region of the face comprises a locking member, the contact member comprises a locking member receiver configured for receiving the locking member.

Typically, the plurality of the contact members further comprises at least one non-electrically conductive contact member which is not adapted to conduct electricity, the structures of the at least one non-electrically conductive contact member and the at least one electrically conductive contact member are of the same.

Typically, the number of the contact member of each input means are of the same.

Typically, the body further comprises a finger receiver configured for receiving an end portion of a human finger.

Typically, the body further comprises a receiver portion in the body.

Typically, the receiver portion of the body is a hollow structure which forms a passage between opposing ends of the body.

Typically, the finger receiver comprises an indication member adapted for indicating the number of the electrically conductive contact member on a face of the body.

Typically, the length between two adjacent electrically conductive contact members of each input means is more than 1 cm.

Typically, the indication member comprises a convex structure, the number of the convex structure and the number of the electrically conductive contact member of the input means on the corresponding face of the body are of the same.

Typically, the indication member comprises an Arabic numeral corresponds to the electrically conductive contact member of the input means on the corresponding face of the body.

Typically, the indication member comprises a second concave region, the number of the second concave region and the number of the electrically conductive contact member of the input means on the corresponding face of the body are of the same.

Typically, the body is a prism-shaped structure, the plurality of the input means are arranged on faces of the body.

Typically, the body is a cubic-shaped structure, the body comprises four input means, the four input means are arranged on the four opposing faces of the cubic-shaped structure of the body

Typically, the body is a triangular prism-shaped structure, the body comprises three input means, the three input means are arranged on three side faces of the body.

Typically, the body is a cylindrical structure, the body comprises two input means, the two input means are arranged on opposing faces of the body.

Typically, the body is a spherical-shaped structure, the input means is arranged on a face of the body.

### BRIEF DESCRIPTION OF THE DRAWINGS

This and other objects, features and advantages of the invention will become apparent upon reading of the following detailed descriptions and drawings, in which:

FIG. 1 is a perspective view of a first embodiment of the present invention;

FIG. 2 is a top view of the device having multi-touch applications in an opening state of FIG. 1;

FIG. 3 is a perspective view showing the application of the device having multi-touch applications of FIG. 1 to a touch screen of tablet computer;

FIG. 4 is a perspective view showing a pen mounted inside and pass through the device having multi-touch applications after the pen is inserted as shown in FIG. 1;

FIG. 5 is the diagram of the through-hole of the device having multi-touch applications after the pen is inserted as the pen holder as shown in FIG. 1;

FIG. 6 is the diagram of the concave region and concave position of the device having multi-touch applications as shown in FIG. 1;

FIG. 7 is the diagram of the concave region comprising blocking members and contact members comprising slots as shown in FIG. 6;

FIG. 8 is the diagram of the electrically conductive contact members of the device having multi-touch applications after removed but mounted behind styluses and electrically conductive rods used as capacitance pens and eraser as shown in FIG. 1.

FIG. 9 is the raised diagram of the setup in the concave position of the device having multi-touch applications as shown in FIG. 6;

FIG. 10 is the structural diagram of the device having multi-touch applications provided by the second embodiment in the present invention;

FIG. 11 is the extended plane diagram of the device having multi-touch applications provided by the third embodiment in the present invention;

FIG. 12 is the diagram of the through-hole of the device having multi-touch applications as shown in FIG. 11;

FIG. 13 is the diagram of the structure of the device having multi-touch applications provided by the fourth embodiment in the present invention;

FIG. 14 is the diagram of the structure of the device having multi-touch applications provided by the fifth embodiment in the present invention.

### DESCRIPTION OF THE PREFERRED EMBODIMENTS

The following is the further description of the present invention in combination with the figures and embodiments.

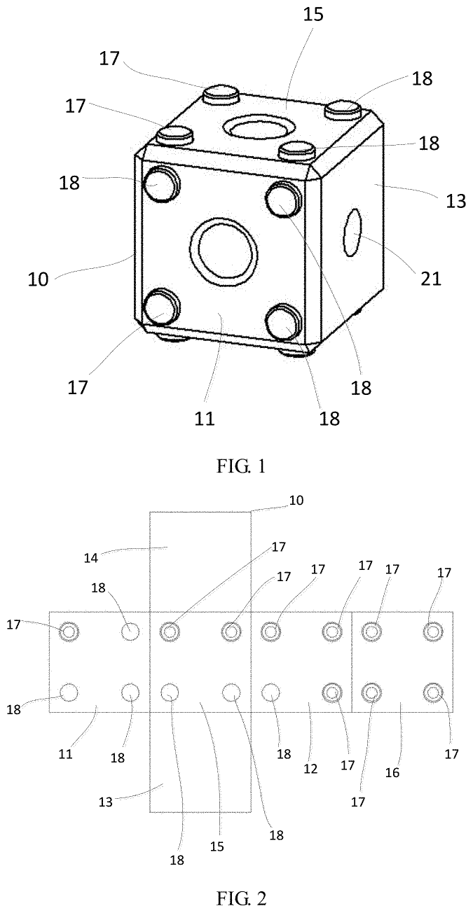

In a first embodiment and referring to FIG. 1 and FIG. 2, the device having multi-touch applications of the present invention can be applied to multi-touch products such as multi-touch screens and multi-touch panels, for example, tablet computers, smart mobile phones, etc to achieve multifunctional touch operation. The device having multi-touch applications comprises a body 10, which comprises at least one input means 101, and each input means 101 comprises a plurality of contact members. Preferably, at least one of the plurality of contact members is an electrically conductive contact member 17. Alternatively, the length between two adjacent electrically conductive contact members of each input means is more than 1 cm. Particularly, the number of electrically conductive contact members 17 of each input means 101 are different. When the body comprises several input means, each input means comprises different numbers of electrically conductive contact members, and each input means touches multi-touch screens and multi-touch panels, etc, each input means's electrically conductive contact members can convey different signals to multi-touch screens and multi-touch panels, etc so as to implement specific touch operations with various functional features

In this embodiment, the body 10 is of a cubic-shaped structure. For the convenience in description, the six faces of the cubic-shaped structure are respectively the corresponding front face 11 and rear face 12, corresponding left face 13 and right face 14, corresponding top end face 15 and the bottom face 16.

The face of the body 10 is preferably made of electrically conductive materials such as aluminum alloy materials so as to implement the touch operation functions. The categories of selected electrically conductive materials do not constitute any restriction for the present invention. Typically, the structure of the body 10 can be a unitary body which is made of electrically conductive materials. Alternatively, the inner structure of the body 10 can be a unitary body which is made of plastic materials and the outer face of the body 10 comprises a layer of electrically conductive materials.

In this embodiment, the body 10 comprises four input means 101. The four input means 101 respectively comprise the front face 11 and the rear face 12, the top face 15 and the bottom face 16 of the cubic-shaped structure 10. Preferably, the contact members of each input means 101 comprise at least one electrically conductive contact member 17. In particular, the number of electrically conductive contact members 17 in each input means 101 are different. The electrically conductive contact members 17 can be made of aluminum alloy materials. Alternatively, the electrically conductive contact members 17 can be made of plastic materials and comprise an electrically conductive layer on its face. As such, the electrically conductive layer can similarly achieve the technical effect of transmission electricity and signals. Preferably, the contact members of the input means 101 mounted on the bottom face 16 are all electrically conductive contact members 17. The part of contact members of the input means 101 which are mounted on the front face 11, the rear face 12 and the top face 15 of the body 10 are electrically conductive contact members 17, the remaining contact members which are mounted on the above faces of the body 10 are all non-electrically conductive contact members 18. The top ends of the plurality of contact members of each input means 101 are on substantially same plane such that the cubic-shaped structure 10 can be securely put on multi-touch screens and multi-touch panels, etc in a balanced position to perform touch operation and to prevent falls of the body 10 due to the unbalanced position of the contact members. The top ends of the plurality of the contact members of each input means are on substantially same plane. Particularly, the directions of plane of the plurality of top ends of the contact member of different input means 101 are different from each other. Preferably, when there is at least one non-electrically conductive conduct member 18 in the plurality of contact members, the electrically conductive contact members 17 and non-electrically conductive contact members 18 are of the same structure. Typically, the electrically conductive contact members 17 and non-electrically conductive contact members 18 can be of a prism-shaped structure. Additionally, the contact ends of electrically conductive contact members 17 and non-electrically conductive contact members 18 are constructed to a hemisphere-shaped structure to facilitate touching action by the user. Through the installation and arrangement of the non-electrically conductive contact members 18 in addition to the electrically conductive contact members 17 on the input means 101, the cubic-shaped structure or the body 10 can be self-balanced and then securely be placed on multi-touch screens and multi-touch panels, etc for touch operation regardless of any risk of falling down of the body 10. Preferably, the electrically conductive contact members 17 and non-electrically conductive contact members 18 can be coated with different colors to facilitate their identifications and the user's touch operation, and moreover, they will easily be distinguished. In this embodiment, when the input means 101 of the cubic-shaped structure 10 is placed on the touch screen, multi-touch panel, or other surface and due to the number of electrically conductive contact members 17 of each input means 101 are different, the touch screen of the electronic device can identify the number of electrically conductive contact members 17 in order to implement certain touch operations with a variety of functional features of the present invention when the contact members of each input means 101 are placed on the touch screen. The distance between two adjacent electrically conductive contact members 17 of each input means 101 is preferably not less than 1 cm so as to facilitate the identification of particular electrically conductive contact members 17 by multi-touch screens, multi-touch panels, etc, and to make corresponding responsive reaction.

Preferably, the number of contact members of each input means can be of the same number. In this embodiment, there are four contact members in each input means 101. The arrangement of the number of contact members in each input means does not have any restriction on the implementation of the present invention. For example, in another embodiment, each input means 101 can comprise five contact members. The way of the arrangement of positioning of contact members in each input means does not allow to have any restriction on the implementation of the present invention. The four contact members can be respectively arranged at four corners of the opposing faces of the cubic-shaped structure 10 or the body 10. Preferably, the four contact members positioned on the bottom face 16 of the cubic-shaped structure 10 or the body 10 are all electrically conductive contact members 17. In the embodiment, referring to the four groups of the four contact members locating on the front face 11, the top face 15 and the rear face 12 of the cubic-shaped structure 10 or the body 10 respectively, the arrangement of the number of electrically conductive contact members 17 are one, two and three respectively and further arrangement of the number of non-electrically conductive contact members 18 are three, two and one respectively. The two electrically conductive contact members 17 located on the top face 15 of the cubic-shaped structure 10 or the body 10 are in a parallel relationship forming a linear dot matrix. The three electrically conductive contact members 17 located on the rear face 12 of the cubic-shaped structure 10 or the body 10 form a dot matrix with a shape of an isosceles triangle. The four electrically conductive contact members 17 located on the bottom face 16 of the cubic-shaped structure 10 or the body 10 form a rectangular-shaped dot matrix. In the circumstances, each of the front face 11, the rear face 12, the top face 15 and the bottom face 16 of the cubic-shaped structure 10 or the body 10 can perform a distinctive functional touch operation. As all of the front face 11, the rear face 12, the top face 15 and the bottom face 16 of the cubic-shaped structure 10 have four contact members, the cubic-shaped structure 10 or the body 10 can be securely placed on a multi-touch screen, or multi-touch panel, etc, in a balanced position.

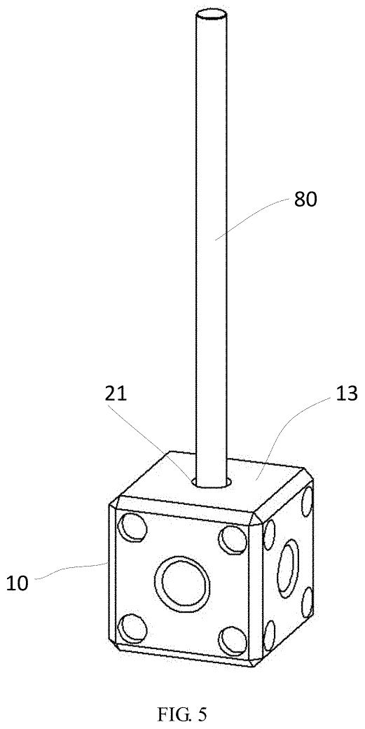

Alternatively, the left face 13 and the right face 14 of the cubic-shaped structure 10 or the body 10 can be defined as opposing faces configured to be held by hand and further, the above opposing faces do not comprise any contact members in which it will not have any barrier of convex structures, such as contact members and can be easily held and operated the body 10 of the present invention by the user. The receiver portions 21 of the body 10 can be arranged on the left face 13 and right face 14 of the cubic-shaped structure 10 or the body 10. Alternatively, the receiver portion 21 of the body 10 can be a hollow structure which forms a passage between opposing ends of the body 10. Referring to FIG. 4, a pen 80 can be received inside the receiver portions 21 of the body 10. As the pen 80 acts as an axis of rotation, the cubic-shaped structure 10 or the body 10 will then be rotated by rotating the pen 80. Alternatively, a spinning top can be formed by mounting the pen 80 inside the receiver portion 21 for the purpose of tension relief and amusement. Referring to FIG. 5, alternatively, a pen holder or a decoration can also be formed by mounting the pen 80 inside the receiver portion 21. Preferably, the receiver portion 21 can be a hole with openings at both ends. Alternatively, both ends of the receiver portion 21 can be chamfered so that the user can use the device comfortably and conveniently.

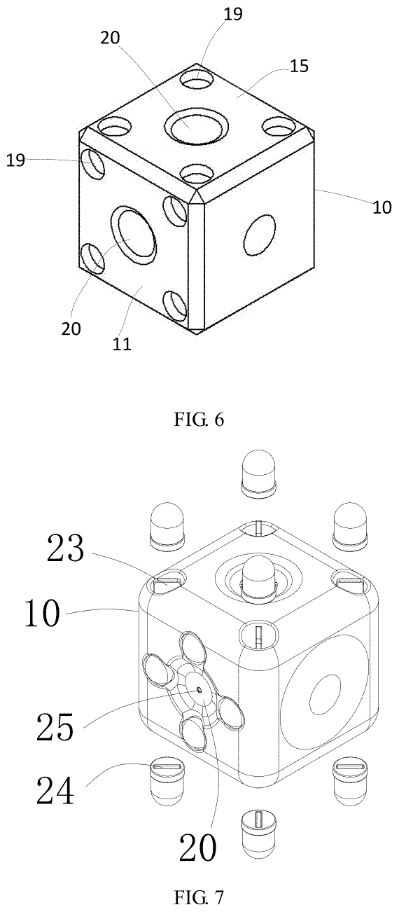

Referring to FIG. 6, the front face 11, the rear face 12, the top face 15 and the bottom face 16 of the cubic-shaped structure 10 or body 10 comprise a plurality of concave regions 19 being arranged on each of the above faces. The concave regions 19 are arranged at the positions of the above faces which are corresponding to the positions of the four contact members of each input means 101. The contact members can be removably mounted to the corresponding first concave region 19. To implement of the present invention, the number of contact members mounted on each face can be changed or amended with the likeness of the user. For example, in this embodiment, all of the front face 11, the rear face 12, the top face 15 and the bottom face 16 comprise four first concave region 19 being arranged on its face. Particularly, four contact members can maximally be mounted on to the front face 11, the rear face 12, the top face 15 and the bottom face 16 to in order to form a number of four contact member means. Alternatively, a contact member can be mounted on the front face 11 in order to form a first contact member means. Further, two contact members can be mounted on the rear face 12 in order to form a second contact member means. Further, three contact members can be mounted on the top face 15 in order to form a third contact member means. Four contact members can be mounted on the bottom face 16 in order to form a fourth contact member means. Alternatively, for example, the cubic-shaped structure 10 or the body 10 can further comprise six concave regions 19. The users can be by their own discretion to choose the designated number of concave regions when necessary, such as two or four concave regions.

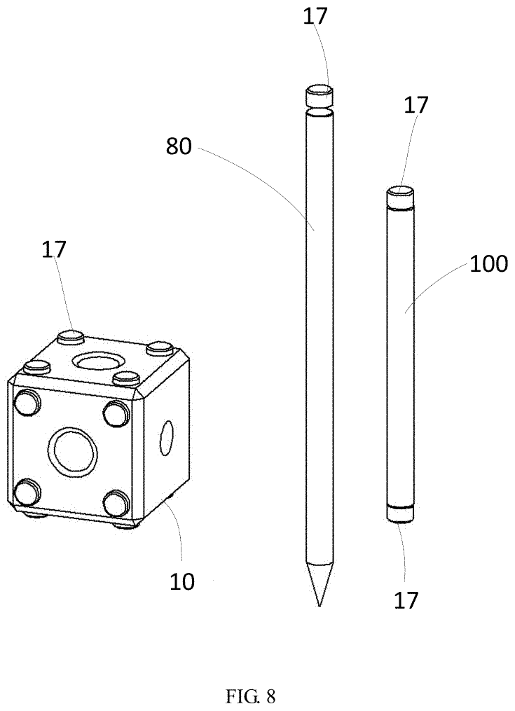

Typically, referring to FIG. 7, the first concave region 19 comprises a locking member 23 arranged inside the first concave region 19, and the contact member comprises a locking member receiver 24, the locking member 23 is configured to be received by the locking member receiver 24 so that the contact members can be removably mounted to the corresponding first concave region 19 for convenience in disassembly. In the present invention, there is no restriction on the shape of the locking member 23 and the shape of the locking member 23 will not provide any limitation on the embodiments of the present invention. Alternatively, referring to FIG. 7, the locking member 23 can be a locking member in a planar-shape or in a cross-shape. Referring to FIG. 8, when the electrically conductive contact members 17 are removably mounted to a pen 80, the pen 80 can become a capacitive pen, or when the electrically conductive contact members 17 is removably mounted to the pen pole 100, the electrically conductive contact members 17 can become as eraser.

Preferably, each of the front face 11, the rear face 12, the top face 15 and the bottom face 16 of the cubic-shaped structure 10 or the body 10 comprises finger receiver 20 configured for allowing a fingertip to place on the finger receiver 20 comfortably so as to have a better control on the movement of the cubic-shaped structure 10 or the body 10. Preferably, the finger receiver 20 can be arranged on the middle portion of the above faces.

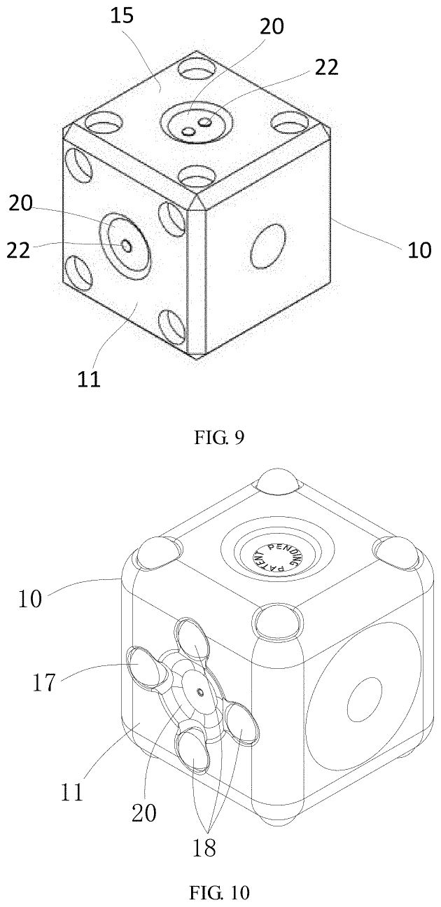

Preferably, the finger receiver 20 comprises an indication member 20 adapted for indicating the number of electrically conductive contact members 17 on the face where such finger receivers 20 is located. This is to allow the user to have a better control on the motion and operation of the cubic-shaped structure 10 or the body 10. Particularly, the user can learn the number of the electrically conductive contact members 17 located on each face by touching the indication member 20 of each face. Typically, the indication member 20 can be of a convex structure 22. Referring to FIG. 9, the front face 11, the rear face 12, the top face 15 and the bottom face 16 of the cubic-shaped structure 10 or the body 10 have at least one convex structure 22 which is arranged inside their respective finger receivers 20. Preferably, the number of the convex structures 22 is the same as the number of electrically conductive contact members 17 on the corresponding faces. To implement this embodiment of the present invention, number of electrically conductive contact members 17 on the faces can easily be found by identifying the number of the convex structures 22 inside the finger receiver 20 on a particular face of the body 10. It is to indicate the user in touch controlling in implementation of this embodiment of the present invention. Alternatively, the indication members 20 can also be convex structures showing Arabic numerals or printed Arabic numerals. Such Arabic numerals can be the same as the number of electrically conductive contact members 17 on the corresponding faces. Similarly, the user can learn the number of electrically conductive contact members 17 on each face according to the Arabic numerals of the particular finger receiver 20. Alternatively, referring to FIG. 7, the indication members 20 can be the second concave region 25 which is arranged inside the finger receiver 20. The number of the second concave regions 25 is the same as the number of electrically conductive contact members 17 on the corresponding faces.

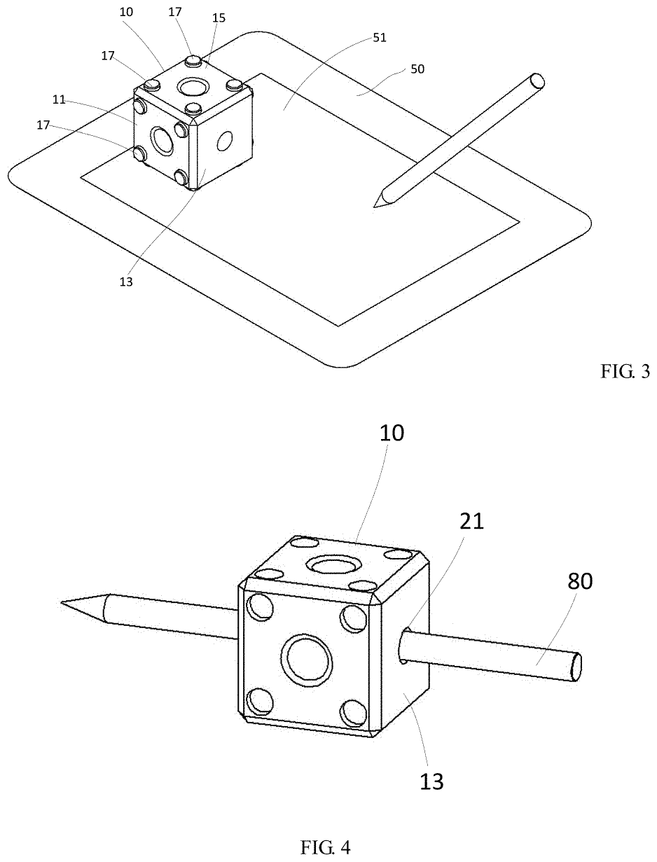

In this embodiment, with reference to FIG. 3, when running a drawing or drafting program in a tablet computer 50 or an electronic touch device, assuming that the eraser tool is selected to implement the erasing function in the above program, the front face 11 of the body 10 can be brought into contact with the touch screen or screen 51 of the tablet computer 50. When the screen 51 recognizes that the input means 101 has only one electrically conductive contact member 17, similar to the case where only one finger or a capacitive pen is recognized to contact the screen 51 at this time, the electrically conductive contact member 17 transmits a signal representing a rubber. When the body 10 is moved, the erasing function can be performed by moving the body 10. Assuming that a ruler is required for drawing or drafting in the above program, the input means 101 positioned on the top surface 15 of the body 10 can be brought into contact with the screen 51 of the tablet computer 50. At this time, the screen 51 recognizes both two electrically conductive contact members 17 contacting the screen 51 of the tablet computer 50 simultaneously. As such, the two electrically conductive contact members 17 transmit a signal for displaying a ruler. A ruler will then be displayed on the screen 51 of the tablet computer 50. The ruler which is displayed on the tablet computer screen can be moved or rotated by moving or rotating the body 10. Typically, the principles of applying other application programs are similar in the implementation of the present invention. Additionally, if a control menu needs to be displayed in a drawing or drafting program or a notepad program, the input means 101 which is positioned on the rear face 12 of the body 10 can be brought into contact with the screen 51 of the tablet computer 50. As such, the three electrically conductive contact members 17 will then touch the screen 51 of the tablet computer 50 simultaneously. Then, the three electrically conductive contact members 17 transmit a signal for displaying the control menu. At this time, a sub-control menu such as copy, save and share functions can be displayed on the screen 51 of the tablet computer 50. Alternatively, by rotating the body 10, the file which is displayed on the screen 51 of the tablet computer 50 can then be enlarged or reduced in size. If a color wheel or palette is required when running the drawing or drafting program, the input means 101 which is positioned on the bottom surface 16 of the body 10 can be contacted with the screen 51 of the tablet computer 50. Four electrically conductive contact members 17 can touch the screen 51 of the tablet computer 50 simultaneously so that the four electrically conductive contact members 17 can then transmit a signal of displaying a color wheel or color palette on the screen 51. Further, the color wheel or color palette will then be displayed on the screen 51 of the tablet computer 50. By rotating the body 10 clockwisely and anti-clockwisely, the color wheel or the color palette which is displayed on the screen of the tablet computer will then be rotated. In another embodiment, when applying the present invention to an electronic game machine and under the electronic game interface, the body 10 can be rotated upwardly and downwardly in order for allowing the electrically conductive contact member 17 of the input means 101 on each surface of the body 10 can touch the screen of the electronic game machine once. After that, the device can therefore transmit a signal to switch the characters or change the gears of those characters for players in the electronic game program. Additionally, by rotating the body 10 in left and right directions, the electrically conductive contact member 17 of the input means 101 which is displayed on each face of the body 10 can touch the screen of the electronic game machine once. The device can then transmit a signal of changing directions of the mode of attack, thereby implementing the change of direction of attack in the electronic game program.

In the second embodiment of the present invention and referring to FIG. 10, this embodiment is different from the first embodiment in that the four contact members of the input means 101 positioned on the front face 11 and the rear face 12 of the body 10 are not located on the four corners of the front face 11 and the rear face 12 respectively. Preferably, the four contact members are arranged on the front face 11 and the rear face 12 respectively and they are located at positions adjacent to the center portions of the front face 11 and the rear face 12 of the body 10. Preferably, the four contact members can be mounted to the finger receivers 20 of the front face 11 and the rear face 12 of the body 10. Alternatively, the four contact member is not required to be mounted to the finger receivers 20 of the front face 11 and the rear face 12 of the body 10.

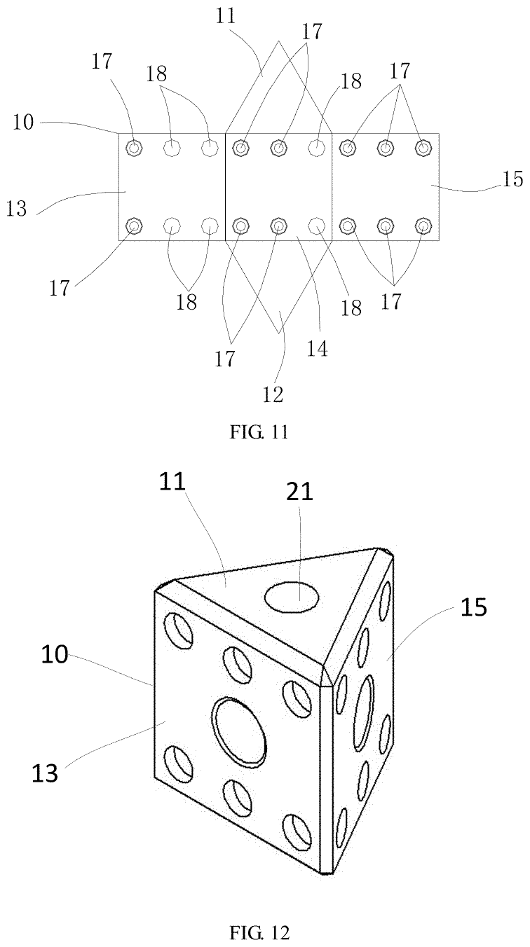

In the third embodiment and referring to FIG. 11 and FIG. 12, this embodiment is different from the first embodiment in that the prism-shaped structure of the body 10 is a triangular prism 10. The triangular prism 10 comprises three input means 101. The triangular prism 10 has five faces. Particularly, such five faces are a top face 11, a bottom face 12, and three side faces. The three input means 101 are respectively disposed on three side faces of the triangular prism 10. The three side faces are a first side face 13, a second side face 14, and a third side face 15.

In this embodiment, each input means 101 comprises six contact members. For these six contact members, three of them are arranged in a row on an upper portion of the corresponding face, and the other three of them are arranged in a row on a lower portion of the corresponding face. The two rows of the contact members are arranged in opposing positions with substantially same distance from the center of the corresponding face. Particularly, six contact members of the third side face 5 are all electrically conductive contact members 17. Preferably, the contact members of the first side face 13 and the second side face 14 comprise two and four electrically conductive contact members 17 respectively. Preferably, the contact members of the first side face 13 and the second side face 14 comprise four and two non-electrically conductive contact members 18 respectively. A plurality of the electrically conductive contact members 17 of the first side face 13 forms a linear dot matrix. A plurality of the electrically conductive contact members 17 of the second side face 14 can form a rectangular dot matrix. A plurality of the electrically conductive contact member 17 of the third side face 15 can form a comparatively larger rectangular dot matrix. Therefore, each of the first side face 13, the second side face 14, and the third side face 15 of the triangular prism 10 or body 10 can comprise a particular technical feature of the embodiment of the present invention. Since the first side face 13, the second side face 14, and the third side face 15 of the triangular prism 10 each have six contact members, no matter which face of the body 10 is placed on the multi-touch screen, multi-touch pad, tablet computer etc., the triangular prism 10 or the body 10 can be maintained in a balanced position on the screen of the tablet computer or multi-touch screen.

To implement this embodiment of the present invention, assuming that a ruler is required for drawing or drafting in the above program, two electrically conductive contact members 17 of the input means 101 which is positioned on the first side face 13 of the body 10 or the triangular prism 10 can be brought into contact with the screen of the tablet computer. At this time, the screen recognizes both two electrically conductive contact members 17 contacting the screen of the tablet computer simultaneously. As such, the two electrically conductive contact members 17 transmit a signal for displaying a ruler. A ruler will then be displayed on the screen of the tablet computer. The ruler which is displayed on the tablet computer screen can be moved or rotated by moving or rotating the body 10. If a color wheel or palette is required when running the drawing or drafting program, four electrically conductive contact members 17 of the input means 101 which is positioned on the second side face 14 of the body 10 or the triangular prism 10 can be contacted with the screen of the tablet computer. Four electrically conductive contact members 17 can touch the screen of the tablet computer simultaneously so that the four electrically conductive contact members 17 can then transmit a signal of displaying a color wheel or color palette on the screen. Further, the color wheel or color palette will then be displayed on the screen of the tablet computer. By rotating the body 10 clockwisely and anti-clockwisely, the color wheel or the color palette which is displayed on the screen of the tablet computer will then be rotated. Additionally, if a drawing tool menu, such as straight line, curve, circle, and ellipse is required to be displayed in a drawing or drafting program, six electrically conductive contact members 17 of the input means 101 which is positioned on the third side face 15 of the body 10 or the triangular prism 10 can be brought into contact with the screen of the tablet computer. As such, the six electrically conductive contact members 17 will then touch the screen of the tablet computer simultaneously. Then, the six electrically conductive contact members 17 transmit a signal for displaying the tool menu and the tool menu will then be displayed on the screen of tablet computer.

The top face 11 and the bottom face 12 of the triangular prism 10 both comprise the receiver portion 21 for receiving fingertips in order to control the triangular prism 10 conveniently.

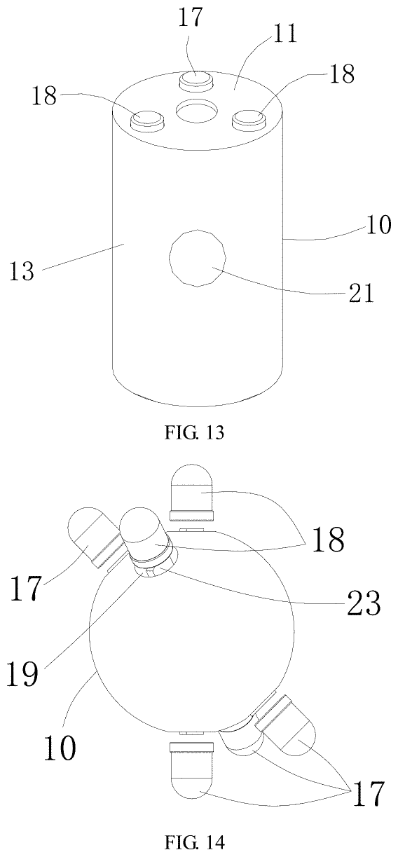

In the fourth embodiment and referring to FIG. 13, this embodiment is different from the first embodiment in that the body is of a prism-shaped structure 10. The cylindrical structure 10 comprises two input means 101. The cylindrical structure 10 or body 10 has three faces. Particularly, the above three faces are the top face 11, the bottom face 12 and the side faces 13. The two input means 101 are respectively arranged on the top face 11 and the bottom face 12 of the cylindrical structure 10 or body 10 respectively.

In this embodiment, each input means 101 comprises three contact members which are uniformly distributed around the central portion of the corresponding face. All three contact members of the input means 101 located on the bottom face 12 of the cylindrical structure 10 or body 10 are the electrically conductive contact members 17. Further, the three contact members of the input means 101 located on the top face 11 of the cylindrical structure 10 or body 10 contains one electrically conductive contact member 17 and two non-electrically conductive contact members 18. The three electrically conductive contact members 17 of the bottom face 12 of the cylindrical structure 10 or body 10 forms an equilateral triangle dot matrix. Therefore, each of the top face 11 and the bottom face 12 of the cylindrical structure 10 or body 10 can comprise a particular technical feature of the embodiment of the present invention. Since the top face 11 and the bottom face 12 of the cylindrical structure 10 or body 10 have three contact members, no matter which face of the body 10 is placed on the multi-touch screen, multi-touch pad, tablet computer etc., the cylindrical structure 10 or the body 10 can be maintained in a balanced position on the screen of the tablet computer or multi-touch screen.

To implement this embodiment of the present invention and referring to FIG. 13, when running a drawing or drafting program in a tablet computer 50 or an electronic touch device, assuming that the eraser tool is selected to implement the erasing function in the above program, the top face 11 of the cylindrical structure 10 or the body 10 can be brought into contact with the touch screen or screen 51 of the tablet computer 50. When the screen 51 recognizes that the input means 101 has only one electrically conductive contact member 17, similar to the case where only one finger or a capacitive pen is recognized to contact the screen 51 at this time, the electrically conductive contact member 17 transmits a signal representing a rubber. When the body 10 is moved, the erasing function can be performed by moving the body 10. Additionally, if a control menu needs to be displayed in a drawing or drafting program or a notepad program, three electrically conductive contact members 17 of the input means 101 which is positioned on the bottom face 12 of the cylindrical structure 10 or the body 10 can be brought into contact with the screen 51 of the tablet computer 50. As such, the three electrically conductive contact members 17 will then touch the screen 51 of the tablet computer 50 simultaneously. Then, the three electrically conductive contact members 17 transmit a signal for displaying the control menu. At this time, a sub-control menu such as copy, save and share functions can be displayed on the screen 51 of the tablet computer 50. Alternatively, by rotating the body 10, the file which is displayed on the screen 51 of the tablet computer 50 can then be enlarged or reduced in size.

The side face 13 of the cylindrical structure 10 or body 10 comprises the receiver portion 21 for receiving fingertips in order to control the cylindrical structure 10 conveniently.

Preferably, when the body 10 of the present invention is a cylindrical structure, under different circumstances, the input means 101 can be arranged on each face. It is preferably that the number of the electrically conductive contact members 17 of the input means 101 among the faces of the body 10 are different with each other. As such, the touch operations of this embodiment of the present invention can be implemented conveniently and effectively.

In the fifth embodiment and referring to FIG. 14, this embodiment is different from the first embodiment in that the body 10 is a spherical structure 10. Each input means 101 is arranged on a face of the spherical structure 10. The spherical structure 10 comprises two input means 101 and the two input means 101 are arranged in opposite positions on the spherical structure 10. One input means 101 is arranged on the upper portion of the spherical structure 10 while the other input means 101 is arranged on the lower portion of the spherical structure 10.

A plurality of the concave regions 19 are arranged on the positions corresponding to the contact members of corresponding input means 101 of the upper surface and the lower surface of the spherical structure 10. The contact members are removably mounted inside the concave regions 19. Preferably, the concave region 19 comprises a locking member 23 inside the concave region 19. The contact member comprises a locking member receiver 24 (not shown in the figures). The locking member 23 can be received inside the locking member receiver 24 in order that the contact member can be removably mounted inside corresponding concave region 19 conveniently.

In this embodiment, each input means 101 comprises three contact members. The contact members of the input means 101 arranged on the upper portion of the spherical structure 10 contain one electrically conductive contact member 17 and two non-electrically conductive contact members 18. Additionally, all three contact members of the input means 101 arranged on the lower portion of the spherical structure 10 are the electrically conductive contact members 17. Preferably, the three electrically conductive contact members 17 of the input means 101 of the lower portion of the spherical structure 10 can be implemented and applied individually. Alternatively, each of three electrically conductive contact members 17 of the input means 101 of the lower portion of the spherical structure 10 can be applied and implemented together or separately by two groups of electrically conductive contact members 17.

To implement this embodiment of the present invention, the user can implement the touch operation of this embodiment by holding the central portion of the spherical structure 10. For example, when running a drawing or drafting program in a tablet computer 50 or an electronic touch device, assuming that the eraser tool is selected to implement the erasing function in the above program, one electrically conductive contact member 17 of the input means 101 which is positioned on the upper portion of the spherical structure 10 or the body 10 can be brought into contact with the touch screen or screen 51 of the tablet computer 50. When the screen 51 recognizes that the input means 101 has only one electrically conductive contact member 17, similar to the case where only one finger or a capacitive pen is recognized to contact the screen 51 at this time, the electrically conductive contact member 17 transmits a signal representing a rubber. When the spherical structure 10 is moved, the erasing function can be performed by moving the spherical structure 10. Additionally, if a control menu needs to be displayed in a drawing or drafting program or a notepad program, three electrically conductive contact members 17 of the input means 101 which is positioned on the lower portion of the spherical structure 10 or the body 10 can be brought into contact with the screen 51 of the tablet computer 50. As such, the three electrically conductive contact members 17 will then touch the screen 51 of the tablet computer 50 simultaneously. Then, the three electrically conductive contact members 17 transmit a signal for displaying the control menu. At this time, a sub-control menu such as copy, save and share functions can be displayed on the screen 51 of the tablet computer 50. Alternatively, by rotating the spherical structure 10 or the body 10, the file which is displayed on the screen 51 of the tablet computer 50 can then be enlarged or reduced in size. Assuming that a ruler is required for drawing or drafting in the above program, the two out of three electrically conductive contact members 17 of the input means 101 which is positioned on the lower portion of the body 10 or the spherical structure 10 can be brought into contact with the screen of the tablet computer. At this time, the screen recognizes both two electrically conductive contact members 17 contacting the screen of the tablet computer simultaneously. As such, the two electrically conductive contact members 17 transmit a signal for displaying a ruler. A ruler will then be displayed on the screen of the tablet computer. The ruler which is displayed on the tablet computer screen can be moved or rotated by moving or rotating the spherical structure 10 or the body 10.

In this embodiment, under the circumstances that the different number of the electrically conductive contact members 17 among each input means 101 on the spherical structure 10, more input means 101 can then be arranged on the spherical structure 10 so that more technical features of the touch operations of this embodiment of the present invention can therefore be implemented and applied conveniently.

The present invention has been described in detail, with reference to the preferred embodiment, in order to enable the reader to practice the invention without undue experimentation. However, a person having ordinary skill in the art will readily recognize that many of the previous disclosures may be varied or modified somewhat without departing from the spirit and scope of the invention. Accordingly, the intellectual property rights to this invention are defined only by the following claims.

1. A device having multi-touch applications comprising a body, wherein the body comprises at least one input means, the input means comprises a plurality of contact members, the plurality of contact members comprises at least one electrically conductive contact member adapted to conduct electricity to an object, the number of the at least one electrically conductive contact member between each input means are different.

2. A device having multi-touch applications according to claim 1, wherein top ends of the plurality of contact members of each input means are arranged on substantially same plane.

3. A device having multi-touch applications according to claim 1, wherein the body comprises at least one face which is made of electrically conductive material.

4. A device having multi-touch applications according to claim 3, wherein the body further comprises at least one face having a first concave region, the contact member is configured for being removably mounted to the concave region of the face.

5. A device having multi-touch applications according to claim 4, wherein the first concave region of the face comprises a locking member, the contact member comprises a locking member receiver configured for receiving the locking member.

6. A device having multi-touch applications according to claim 5, wherein the plurality of the contact members further comprises at least one non-electrically conductive contact member which is not adapted to conduct electricity, the structures of the at least one non-electrically conductive contact member and the at least one electrically conductive contact member are of the same.

7. A device having multi-touch applications according to claim 6, wherein the number of the contact member of each input means are of the same.

8. A device having multi-touch applications according to claim 7, wherein the body further comprises a finger receiver configured for receiving an end portion of a human finger.

9. A device having multi-touch applications according to claim 8, wherein the body further comprises a receiver portion in the body.

10. A device having multi-touch applications according to claim 9, wherein the receiver portion of the body is a hollow structure which forms a passage between opposing ends of the body.

11. A device having multi-touch applications according to claim 9, wherein the finger receiver comprises an indication member adapted for indicating the number of the electrically conductive contact member on a face of the body.

12. A device having multi-touch applications according to claim 11, wherein the length between two adjacent electrically conductive contact members of each input means is more than 1 cm.

13. A device having multi-touch applications according to claim 11, wherein the indication member comprises a convex structure, the number of the convex structure and the number of the electrically conductive contact member of the input means on the corresponding face of the body are of the same.

14. A device having multi-touch applications according to claim 11, wherein the indication member comprises an Arabic numeral corresponds to the electrically conductive contact member of the input means on the corresponding face of the body.

15. A device having multi-touch applications according to claim 11, wherein the indication member comprises a second concave region, the number of the second concave region and the number of the electrically conductive contact member of the input means on the corresponding face of the body are of the same.

16. A device having multi-touch applications according to claim 11, wherein the body is a prism-shaped structure, the plurality of the input means are arranged on faces of the body.

17. A device having multi-touch applications according to claim 16, wherein the body is a cubic-shaped structure, the body comprises four input means, the four input means are arranged on the four opposing faces of the cubic-shaped structure of the body

18. A device having multi-touch applications according to claim 16, wherein the body is a triangular prism-shaped structure, the body comprises three input means, the three input means are arranged on three side faces of the body.

19. A device having multi-touch applications according to claim 16, wherein the body is a cylindrical structure, the body comprises two input means, the two input means are arranged on opposing faces of the body.

20. A device having multi-touch applications according to claim 16, wherein the body is a spherical-shaped structure, the input means is arranged on a face of the body.
